(19) United States
(12) Patent Application Publication
(10) Pub. No.: US 2026/0120238 A1
(43) Pub. Date: Apr. 30, 2026

(54) UP-RESOLUTION OF SIGNED DISTANCE FIELD (SDF) VOXELS

(71) Applicant: Adobe Inc., San Jose, CA (US)

(72) Inventors: Zhiqin Chen, Seattle, WA (US); Vladimir Kim, Seattle, WA (US); Siddhartha Chaudhuri, Bangalore (IN); Matheus Abrantes Gadelha, Amherst, MA (US); Anton Kirczenow, Guildford (GB)

(73) Assignee: Adobe Inc., San Jose, CA (US)

(21) Appl. No.: 18/929,259

(22) Filed: Oct. 28, 2024

(51) Int. Cl. G06T 3/4053; G06T 3/4046; G06T 7/73

(52) U.S. Cl. CPC G06T 3/4053; G06T 3/4046; G06T 7/75

(57) ABSTRACT

In implementations of techniques and systems up-resolution of signed distance field (SDF) voxels in volumetric sculpting software, a processing device receives signed distance values of voxels in a first voxel grid to represent a three-dimensional (3D) object. For each voxel in the first voxel grid, the processing device determines whether the voxel is located near the surface of the 3D object. A machine-learning model then upsamples each target voxel near the surface into signed distance values of multiple voxels in a second voxel grid having a greater resolution than the first voxel grid. The machine-learning model uses the signed distance values of neighboring voxels of the target voxel. The processing device renders the 3D object using the signed distance values of the voxels in the second voxel grid.

### BACKGROUND

Creating realistic objects and characters for various applications such as video animation, games, and other media is important. One three-dimensional (3D) modeling technique, called volumetric sculpting, focuses on manipulating the volume of a digital object rather than just its surface to generate realistic objects. Volumetric sculpting provides a more intuitive and organic way of modeling than other techniques (e.g., parametric modeling), but it also introduces various technical challenges that can cause visual artifacts as 3D models are up-sampled to add finer details for final rendering or export.

### SUMMARY

Techniques and systems for up-resolution of SDF voxels in volumetric sculpting software are described. In one example, a processing device receives a first voxel grid representing a three-dimensional (3D) object. For each target voxel near a surface of the 3D object, a machine-learning model upsamples the target voxel into multiple voxels in a second voxel grid having a resolution greater than that of the first voxel grid. The machine-learning model is trained on synthetic shapes to determine the signed distance values of the multiple voxels in the second voxel grid based on the signed distance values of neighboring voxels (e.g., in a four-by-four-by-four grid) in the first voxel grid. The processing device then renders the 3D object using the voxels of the second voxel grid with improved resolution.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures. Entities represented in the figures indicate one or more entities, and thus, reference is made interchangeably to single or plural forms of the entities in the discussion.

FIG. 1 illustrates a digital medium environment in an example implementation that is operable to employ up-resolution of SDF voxels as described herein.

FIG. 2 is a flow diagram depicting an algorithm as a step-by-step procedure in an example implementation of operations performable for accomplishing up-resolution of SDF voxels.

FIG. 3 illustrates an example process for determining which voxels are near the surface as described herein.

FIG. 4 illustrates an example process for upsampling SDF voxels using a machine-learning model as described herein.

FIG. 5 illustrates an example of rendered objects generated using the described SDF-voxel up-resolution techniques versus a conventional upsampling technique.

FIG. 6 illustrates an example of rendered objects generated using the described SDF-voxel up-resolution techniques versus a conventional upsampling technique.

FIG. 7 illustrates an example system including various components of an example device that can be implemented as any type of computing device as described and/or utilized with reference to the previous figures to implement embodiments of the techniques described herein.

### DETAILED DESCRIPTION

### Overview

The movie industry and the visual effects community employ volumetric sculpting tools to create realistic digital objects and characters. Despite advancements in high-end modeling systems, generating 3D models with sharp features and faithful representation of geometric features remains difficult, especially after using up-resolution tools to add finer details for final renderings or export. This document introduces techniques and systems for the voxel up-resolution of 3D models in volumetric sculpting modeling software.

Volumetric sculpting generally stores signed distances in voxel grids and then runs a polygon extraction algorithm (e.g., marching cubes, dual contouring, or dual marching cubes) to extract a mesh for modeled objects. A voxel, short for volumetric pixel, is the 3D equivalent of a pixel in a 2D image. Voxels are generally tiny cubes within a 3D grid that combine to create a 3D representation of a modeled object. Each voxel holds a value that represents one or more object properties (e.g., color, density, material type) and signed distances.

Signed distances represent the geometry of modeled objects using a mathematical function. Instead of defining a 3D object with a set of polygons (e.g., triangles and squares), signed distances use a function that takes a point in 3D space as input and returns a value indicating the distance to the closest surface of the object. The sign of the value indicates whether the point is inside (e.g., a negative value) or outside (e.g., a positive value) the object. On the surface of the object, the value is equal to zero.

Creating a 3D model often involves using lower-resolution signed distance field (SDF) voxels, for example, a voxel grid representing a discretized signed distance field for sculpting and optimizing computational resources in volumetric sculpting software. Once the initial model is ready, artists convert the 3D model into higher-resolution SDF voxels to add intricate details for the final rendering or export. However, conventional up-resolution techniques struggle to accurately preserve the geometric intricacies, such as sharp edges and corners, without introducing unwanted surface artifacts.

In contrast, the systems and techniques described herein introduce up-resolution of SDF voxels that maintain the shape and features of modeled objects using machine learning. The described approach is efficient enough to be integrated into volumetric sculpting software. The described systems and techniques involve training a neural network on synthetic 3D shape data to learn to upsample SDF voxels into higher resolutions. Unlike conventional deep learning techniques such as 3D convolutional neural networks that process each voxel in the input voxel grid, the described neural network just processes voxels close to the modeled object's surface, leading to gains in computational and memory efficiency. In this way, the described techniques provide an efficient way for volumetric sculpting tools to upsample sharp features and accurately preserve geometric features during up-resolution for final renderings.

The following discussion describes an example environment that employs the techniques described herein. Example procedures are also described as performable in the example and other environments. Consequently, the performance of the example procedures is not limited to the example environment, and the example environment is not limited to the performance of the example procedures.

### Example SDF Voxel Up-Resolution Environment

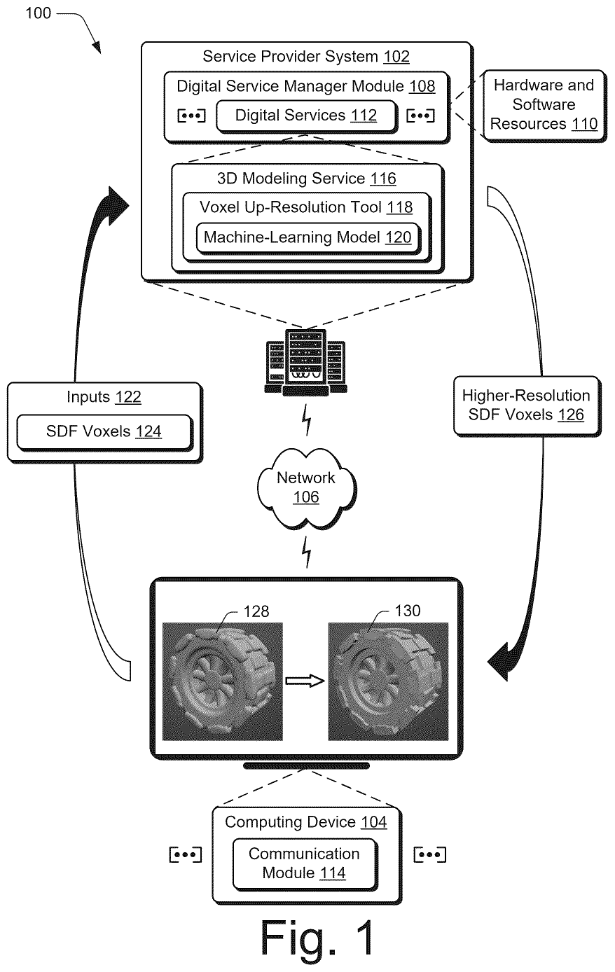

FIG. 1 illustrates a digital medium environment 100 in an example implementation that is operable to employ up-resolution of SDF voxels as described herein. The illustrated digital medium environment 100 includes a service provider system 102 and a computing device 104 that are communicatively coupled, one to another, via a network 106. Computing systems for the service provider system 102 and the computing device 104 are configurable in various ways. For instance, computing device 104 is associated with a user, and service provider system 102 is a remote computing system (e.g., one or more servers) configured to employ the described techniques and systems for up-resolution of SDF voxels in volumetric sculpting software.

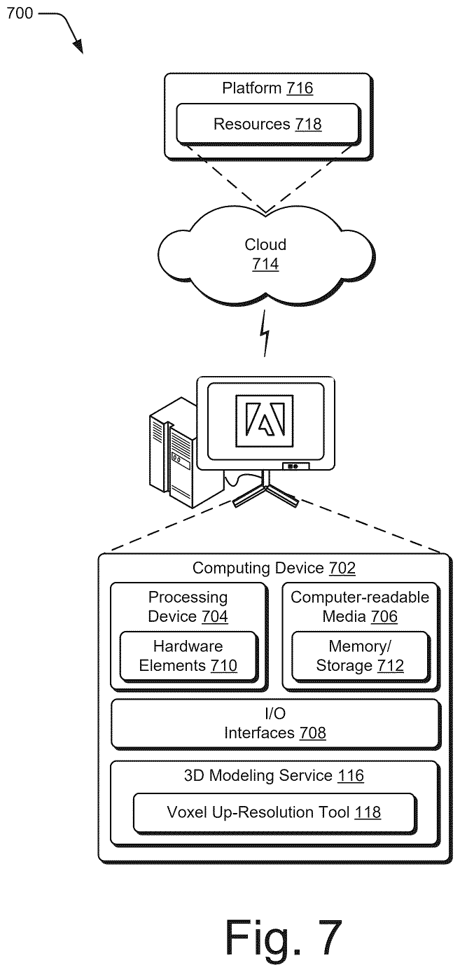

A computing system, for instance, is configurable as a desktop computer, laptop computer, mobile device (e.g., assuming a handheld configuration such as a tablet or mobile phone), server, and so forth. Thus, the service provider system 102 or the computing device 104 can range from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described with FIG. 7.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a 3D modeling service 116 for generating and manipulating 3D objects using volumetric sculpting techniques. Although illustrated as implemented remotely by the service provider system 102, the functionality of the 3D modeling service 116 is also configurable for local implementation, e.g., as part of the computing device 104. The 3D modeling service 116 includes a voxel up-resolution tool 118, which uses a machine-learning model 120 to faithfully preserve geometric details in original shapes as it performs upsampling to higher-resolution voxels.

To generate higher-resolution 3D objects, the voxel up-resolution tool 118 receives inputs 122, which includes low-resolution SDF voxels 124 in a voxel grid. The SDF voxels 124 provide a signed distance value for each vertex in the voxel grid. In other implementations, a representation of an object is provided as an input 122, and the 3D modeling service 116 extracts or determines the SDF voxels 124 for each vertex.

To conserve memory and computation resources, the voxel up-resolution tool 118 uses the machine-learning model 120 to process SDF voxels 124 near the surface of the 3D object and another up-resolution technique to process the other SDF voxels 124. For each SDF voxel 124 near the surface, the machine-learning model 120 upsamples each target voxel into a two-by-two-by-two grid of sub-voxels, achieving an up-resolution factor of two for higher-resolution SDF voxels 126. From the SDF voxels 124 of a low-resolution 3D object 128, the voxel up-resolution tool 118 processes inputs 122 to generate a rendered 3D object 130 with higher-resolution SDF voxels 126 with faithfully reproduced sharp or smooth features without generating surface artifacts.

In general, functionality, features, and concepts described in the examples above and below are employed in the context of the example procedures described in this section. Further, functionality, features, and concepts described with different figures and examples in this document are interchangeable and are not limited to implementation in the context of a particular figure or procedure. Moreover, blocks associated with different representative procedures and corresponding figures herein are applicable together and/or combinable in different ways. Thus, individual functionality, features, and concepts described with different example environments, devices, components, figures, and procedures herein are usable in any suitable combinations and are not limited to the particular combinations represented by the enumerated examples in this description.

### Example SDF Voxel Up-Resolution Procedure

The following discussion describes up-resolution techniques that are implementable utilizing the described systems and devices. Aspects of each procedure are implemented in hardware, firmware, software, or a combination thereof. The procedure is illustrated as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1, 3, and 4.

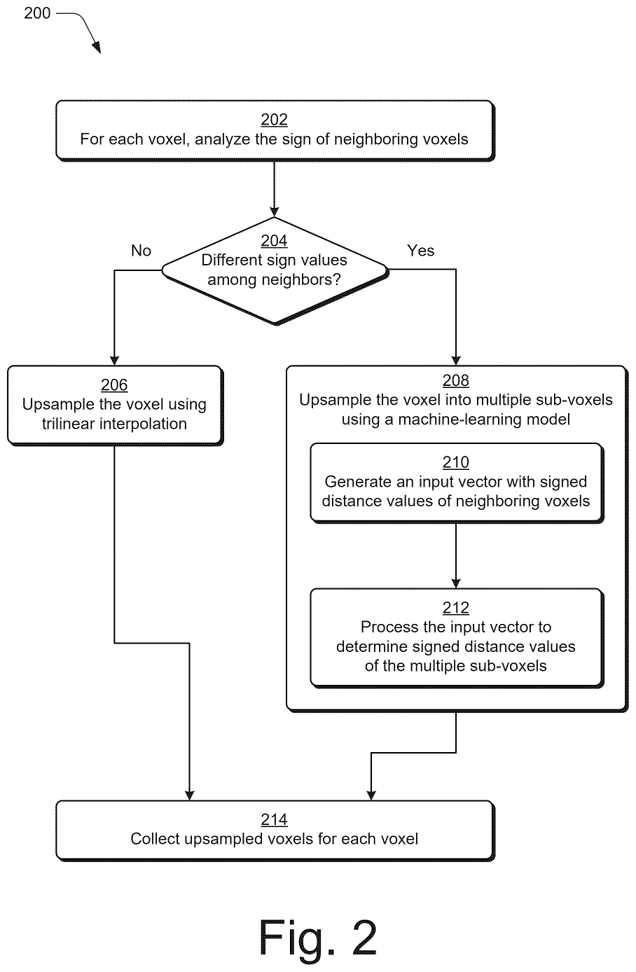

FIG. 2 is a flow diagram depicting an algorithm as a step-by-step procedure 200 in an example implementation of operations performable for accomplishing up-resolution of SDF voxels. In this example, a processing device determines, receives, and/or stores the signed distance of each vertex in a voxel grid. In particular, the 3D modeling service 116 determines, receives, or stores the signed distance values as part of an up-resolution task performed by the voxel up-resolution tool 118.

For each voxel (referred to as the “target voxel”), the processing device analyzes the sign of the signed distance values of neighboring voxels (block 202). In particular, the voxel up-resolution tool 118 analyzes the sign of the signed distance values for the target voxel's three-by-three-by-three neighbor voxels, with the target voxel at the center of the 3×3×3 voxel grid. If the neighboring voxels include both positive and negative signed distance values, the target voxel is near the surface of the 3D object 128. However, if the neighboring voxels do not include different signs, the target voxel is not near the surface (e.g., it is inside or outside the 3D object 128).

The processing device determines whether there are different sign values among the neighboring voxels of the target voxel (block 204). In other words, the processing device determines whether negative and positive signed distance values exist within the three-by-three-by-three neighboring voxels. In other implementations, a different grid size or alternative technique is used to determine whether the target voxel is near or on the surface. Because voxels near the surface of the 3D object 128 are meaningful for up-resolution purposes, the voxel up-resolution tool 118 uses the machine-learning model 120 to process target voxels near the surface individually and a more efficient up-resolution technique for the other voxels to conserve memory and computation resources.

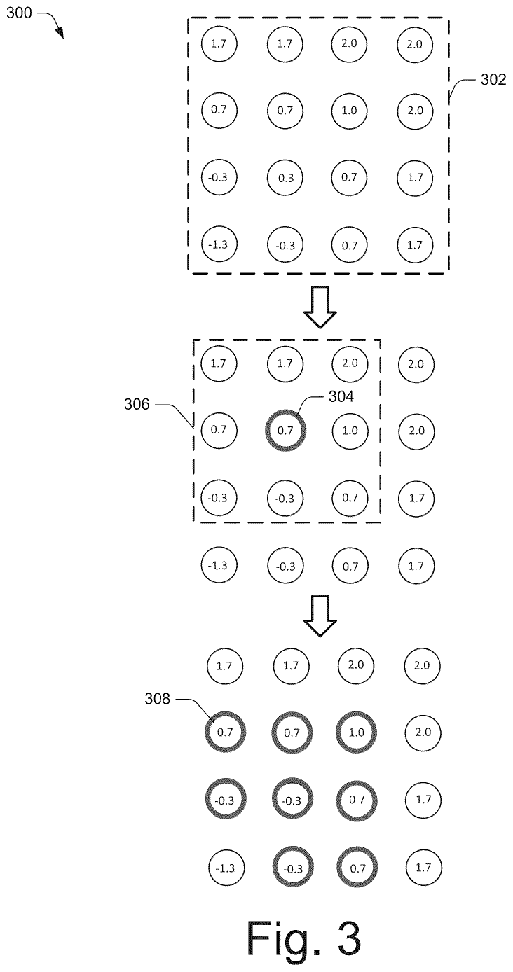

FIG. 3 illustrates an example process 300 for determining which voxels are near the surface as described herein. Voxel grid 302 illustrates a collection of SDF voxels with the corresponding signed distance values at their center. Although the data points are illustrated in two dimensions, the described techniques run in three dimensions. The voxel grid 302 includes a series of signed distances, which indicate the distance to the closest surface of the modeled object. As described above, the sign of the value indicates whether the voxel is inside (negative value) or outside (positive value) of the object.

For a target voxel 304, the processing device identifies a three-by-three-by-three (3×3×3) voxel grid 306. Although illustrated in two dimensions, the 3×3×3 voxel grid 306 also includes a three-by-three (3×3) collection of voxels above and below (the page) the illustrated 3×3 grid. Because the 3×3×3 voxel grid 306 includes positive and negative signed distance values, target voxel 304 is identified as a near-surface voxel. A similar analysis is performed for each voxel in voxel grid 302 with the near-surface voxels 308 illustrated with a thick border in FIG. 3.

If there are not different sign values among the neighboring voxels (e.g., the voxel is not near the surface of the 3D object or a “no” determination at block 204), the voxel up-resolution tool 118 uses trilinear interpolation to upsample the target voxel (block 206).

Trilinear interpolation estimates the value of a function at a point within a 3D voxel grid. In particular, the processing device identifies the surrounding cube by determining the eight corner points of the cube that enclose the target voxel. The processing device then performs bilinear interpolation on two opposite faces of the cube to obtain two intermediate values. Linear interpolation is performed between the two intermediate values to obtain the final estimated SDF value at the desired voxel. In other words, trilinear interpolation involves a series of linear interpolations in three dimensions to approximate the value at a specific point within the voxel grid. The processing device performs naïve trilinear interpolation by implementing trilinear interpolation without optimization or boundary condition considerations. In other implementations, the voxel up-resolution tool 118 uses another efficient up-resolution technique for the voxels sufficiently “far” from the surface.

If there are different sign values among the neighboring voxels (e.g., the voxel is near the surface of the 3D object or a “yes” determination at block 204), the voxel up-resolution tool 118 uses the machine-learning model 120 to upsample the target voxel into multiple sub-voxels (block 208). In particular, the machine-learning model 120 upsamples the target voxel into eight sub-voxels in a two-by-two-by-two (2×2×2) higher-resolution voxel grid.

In one implementation, the machine-learning model 120 is a multilayer perceptron (MLP), a neural network architecture that includes multiple layers of interconnected nodes (e.g., artificial neurons). MLPs generally include three types of layers: an input layer, a hidden layer, and an output layer. The input layer receives the initial data (e.g., signed distance values of neighboring voxels) that the network processes. Each node in the input layer represents a single feature or value from the input data. In one implementation, the input to the MLP is a 64-dimensional (64-d) vector storing the signed distances for the 4×4×4 neighbor voxels of the target voxel (e.g., a 4×4×4 voxel grid surrounding the target surface voxel).

MLPs include one or more hidden layers, each including multiple artificial neurons that communicate with each other through weighted connections. The output layer provides the final results of the MLP's computation, with the number of nodes depending on the problem. Each neuron in the hidden and output layers applies an activation function to its input to introduce non-linearity into the network. In one implementation, the output is an eight-dimensional (8-d) vector representing the eight sub-voxels in a two-by-two-by-two (2×2×2) grid for the target voxel (as described in greater detail for block 212).

The size of the input and output vectors vary in other implementations. For example, the input vector is a 125-dimensional vector obtained from a five-by-five-by-five (5×5×5) grid of neighboring voxels for a two-by-two-by-two grid of target voxels. In this implementation, the output vector is a 27-dimensional vector, representing a three-by-three-by-three grid with an up-resolution factor of 1.5.

The machine-learning model 120 is trained using synthetic shapes. For example, primitive shapes (e.g., cuboids, spheres, cylinders, pyramids) are randomly selected, and constructive solid geometry operations are performed between them to generate training shapes with sharp features. Additional training data is generated by applying Gaussian filters on the SDF voxels of the synthetic training shapes to generate synthetic shapes with smooth surfaces.

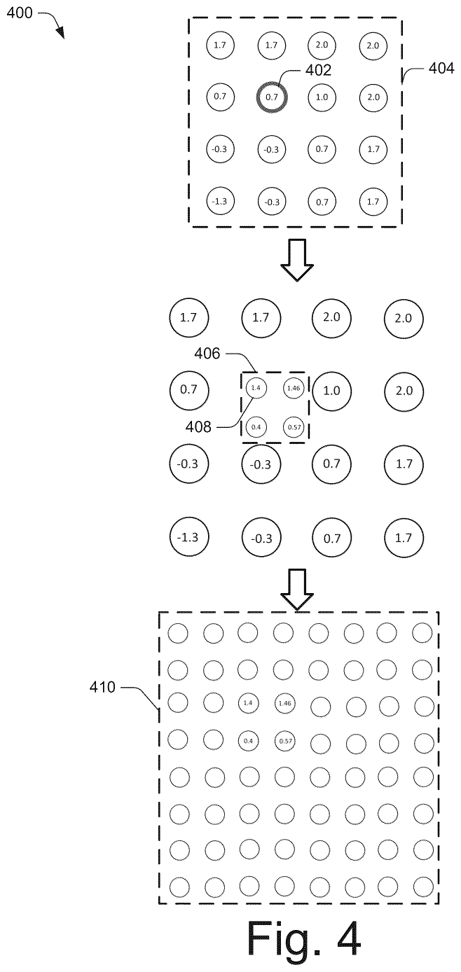

The processing device generates an input vector with signed distance values of the neighboring voxels for the target voxel (block 210). For example, the processing device gathers the signed distance values of the four-by-four-by-four neighboring voxels into a 64-dimensional vector. In one implementation, the target voxel is the second-from-top, second-from-left-hand-side, and second-from-front voxel (as illustrated in 2D in FIG. 4).

The machine-learning model 120 then processes the input vector to determine the signed distance values of the multiple sub-voxels (block 212). For example, each target vector corresponds to an eight-dimensional vector representing the signed distance values of the eight sub-voxels in the two-by-two-by-two grid.

FIG. 4 illustrates an example process 400 for upsampling SDF voxels using a machine-learning model as described herein. For each target voxel 402, the processing device identifies a four-by-four-by-four voxel grid 404 of neighboring voxels. In FIG. 4, voxel grid 404 illustrates a collection of SDF voxels with the corresponding signed distance values at their center. Although the data points are illustrated in two dimensions, the described techniques run in three dimensions. The voxel grid 404 includes a series of signed distances, which indicate the distance to the closest surface of the modeled object. The SDF values for the 64 voxels in voxel grid 404 are concatenated into a 64-dimensional input vector.

The machine-learning model 120 (e.g., a trained MLP) processes the input vector and outputs an eight-dimensional output vector, including the SDF values of the two-by-two-by-two voxel grid 406 upsampled from the target voxel 402. In the illustrated example, the target voxel 402 was located in the top-left-front quadrant of the 4×4×4 voxel grid 404; therefore, a corresponding voxel 408 in the top-left-front position of the 2×2×2 voxel grid 406 is equal to the resolution factor (e.g., two in the illustrated example) multiplied by the original SDF value of the target voxel 402 (e.g., 0.7 in the illustrated example). In this way, the machine-learning model 120 preserves the SDF value of the target voxel 402. In other implementations, the target voxel 402 and the corresponding voxel 408 are located in different relative positions of the 4×4×4 voxel grid 404 and the 2×2×2 voxel grid 406.

Based on its training, the machine-learning model 120 infers the SDF value of the other seven voxels in the 2×2×2 voxel grid 406. Once the machine-learning model 120 has processed each target voxel near the surface, a higher-resolution SDF voxel grid 410 is compiled, along with the upsampled SDF voxels generated using trilinear interpolation.

Returning to procedure 200 of FIG. 2, the processing device collects the upsampled voxels (e.g., using both naïve trilinear interpolation and the machine-learning model 120) for each target voxel in the higher-resolution voxel grid for the rendered 3D object 130 (block 214).

### Example Up-Resolution of SDF Voxels

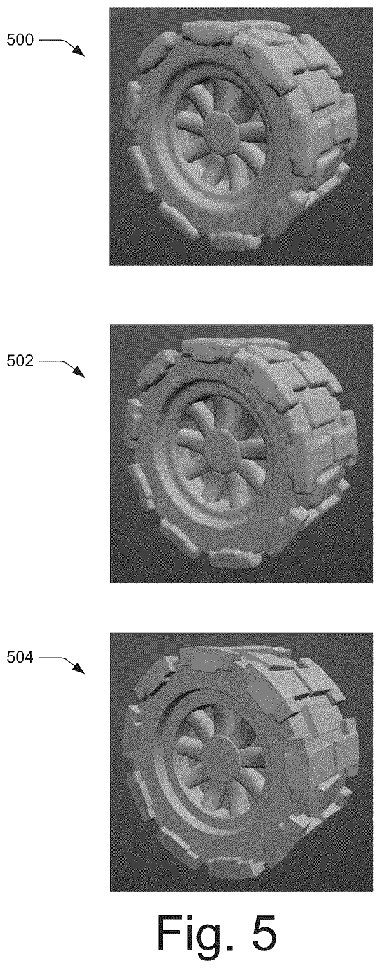

FIG. 5 illustrates an example of rendered objects generated using the described SDF-voxel up-resolution techniques versus a conventional upsampling technique. The original object 500 is a 3D wheel model generated with low-resolution SDF voxels.

In the first example, object 500 is upsampled using a trilinear interpolation technique to generate object 502. As described above, trilinear interpolation is a conventional up-resolution technique that creates new data points by estimating values at intermediate points within a set of existing data points via linear interpolation. As illustrated, object 502 has smoothed out some of the details in the original object 500 by interpolating between the existing data points and introduced stairstep artifacts on the interior edges of the wheel. In contrast, object 504 is generated using the described SDF-voxel up-resolution techniques to sharpen the edges and details of the wheel shape in the original object 500. In other words, the edges and features are better sharpened in rendered object 504 than in object 502.

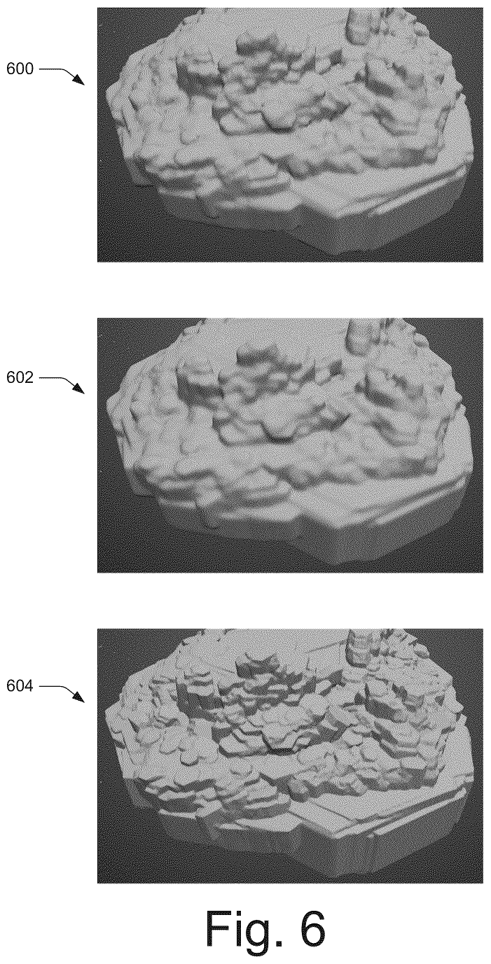

FIG. 6 illustrates an example of rendered objects generated using the described SDF-voxel up-resolution techniques versus a conventional upsampling technique. The original object 600 is a 3D terrain model generated with low-resolution SDF voxels. Object 600 includes projections of random cross-sections, heights, and occurrences.

In the first example, object 600 is upsampled using a tricubic interpolation technique to generate object 602. Tricubic interpolation is a conventional up-resolution technique that creates new data points by estimating values at intermediate points within a set of existing data points using cubic polynomials in multiple dimensions. As illustrated, object 602 has smoothed out many of the details in the original object 600 by interpolating between the existing data points, resulting in the loss of sharp edges and details. In contrast, object 604 is generated using the described SDF-voxel up-resolution techniques to sharpen the edges and details of the terrain features in the original object 600. In other words, the different terrain features are better pronounced in rendered object 604 than in object 602.

### Example System and Device

FIG. 7 illustrates an example system 700 that includes an example computing device 702 that represents one or more computing systems and/or devices usable to implement the techniques described herein. This is illustrated by including the 3D modeling service 116 and the voxel up-resolution tool 118. The computing device 702 is configurable, such as a service provider server, a device associated with a client (e.g., a client device), an on-chip system, and/or any other suitable computing device or computing system.

The example computing device 702, as illustrated, includes a processing system 704, one or more computer-readable media 706, and one or more I/O interfaces 708 that are communicatively coupled, one to another. Although not shown, the computing device 702 further includes a system bus or other data and command transfer system that couples the various components from one to another. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processing system 704 represents the functionality to perform one or more operations using hardware. Accordingly, the processing system 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. Memory/storage 712 represents memory or storage capacity associated with one or more computer-readable media. In one example, the memory/storage 712 includes volatile media (such as random access memory (RAM)) and/or nonvolatile media (such as read-only memory (ROM), Flash memory, optical disks, magnetic disks, and so forth). In another example, the memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 represent functionality that allows a user to enter commands and information to computing device 702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in various ways to support user interaction, as further described below.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computing device 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 710. For example, the computing device 702 is configured to implement particular instructions and/or functions corresponding to the software and/or hardware modules. Accordingly, implementation of a module executable by the computing device 702 as software is achieved at least partially in hardware, e.g., through computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supportable by various configurations of the computing device 702 and are not limited to the specific examples of the techniques described herein. This functionality is also implementable entirely or partially through a distributed system, such as over a “cloud” 714, as described below.

Cloud 714 includes and/or represents a platform 716 for resources 718. The platform 716 abstracts the underlying functionality of hardware (e.g., servers) and software resources of the cloud 714. For example, resources 718 include applications and/or data utilized while computer processing is executed on servers remote from the computing device 702. In some examples, the resources 718 also include services provided over the Internet and/or through a subscriber network, such as a cellular or Wi-Fi network.

Platform 716 abstracts the resources 718 and functions to connect the computing device 702 with other computing devices. In some examples, the platform 716 also serves to abstract scaling of resources to provide a corresponding level of scale to encountered demand for the resources implemented via the platform. Accordingly, in an interconnected device embodiment, the implementation of functionality described herein is distributable throughout system 700. For example, the functionality is implementable in part on the computing device 702 and via the platform 716, which abstracts the functionality of the cloud 714.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, signed distance values of voxels in a first voxel grid having a first resolution to represent a three-dimensional (3D) object;
for each voxel in the first voxel grid, determining, by the processing device and based on the signed distance values of first neighboring voxels, whether the voxel is located near a surface of the 3D object;
for each target voxel near the surface of the 3D object, upsampling, using a machine-learning model and based on the signed distance values of second neighboring voxels, the signed distance value of the target voxel into the signed distance values of multiple voxels in a second voxel grid having a second resolution that is greater than the first resolution; and
rendering, by the processing device and using the signed distance values of the multiple voxels in the second voxel grid, the 3D object.

2. The method of claim 1, wherein:
the machine-learning model is a multilayer perceptron;
for each target voxel, an input to the multilayer perceptron is an input vector that includes the signed distance values for the second neighboring voxels of the target voxel; and
for each target voxel, an output from the multilayer perceptron is an output vector that includes the signed distance values of the multiple voxels upsampled from the target voxel.

3. The method of claim 2, wherein:
the input vector is a 64-dimensional vector that includes the signed distance values for the second neighboring voxels of the target voxel in a four-by-four-by-four voxel grid surrounding the target voxel; and
the output vector is an eight-dimensional vector that includes the signed distance values of the multiple voxels in a two-by-two-by-two voxel grid.

4. The method of claim 3, wherein the second resolution is twice that of the first resolution.

5. The method of claim 2, wherein the multilayer perceptron is trained to determine the output vector based on synthetic 3D shape data generated by performing geometry operations between random selections of primitive shapes.

6. The method of claim 5, wherein:
the primitive shapes include cuboids, spheres, cylinders, and pyramids; and
additional synthetic 3D shape data is generated by applying Gaussian filters on the synthetic 3D shape data.

7. The method of claim 1, wherein determining whether the voxel is located near the surface of the 3D object comprises, for each voxel in the first voxel grid:
determining signs of the signed distance values of the first neighboring voxels; and
in response to the signed distance values for the first neighboring voxels including at least one positive sign distance value and at least one negative sign distance value, determining that the voxel is located near the surface of the 3D object.

8. The method of claim 7, wherein the first neighboring voxels include, for each voxel in the first voxel grid, a three-by-three-by-three voxel grid of voxels surrounding the voxel.

9. The method of claim 7, wherein the method further comprises upsampling, for each voxel not near the surface of the 3D object, the signed distance value of the voxel into the signed distance value of one or more additional voxels using trilinear interpolation.

10. The method of claim 9, wherein each voxel of the first voxel grid is upsampled using one of naïve trilinear interpolation or the machine-learning model.

11. A system comprising:
a memory component; and
one or more processing devices coupled to the memory component, the one or more processing devices to perform operations comprising:
receive a first voxel grid having a first resolution to represent a three-dimensional (3D) object;
for each target voxel near a surface of the 3D object, upsample, using a machine-learning model and based on neighboring voxels, the target voxel into multiple voxels in a second voxel grid having a second resolution that is greater than the first resolution; and
render, using the multiple voxels in the second voxel grid, the 3D object.

12. The system of claim 11, wherein the one or more processing devices perform additional operations comprising model software based on volumetric sculpting with signed distance values for each voxel in the first voxel grid.

13. The system of claim 12, wherein the one or more processing devices perform additional operations comprising:
for each voxel in the first voxel grid, determine, based on the signed distance values of other neighboring voxels, whether the voxel is located near the surface of the 3D object.

14. The system of claim 13, wherein the one or more processing devices perform additional operations comprising determine whether the voxel is located near the surface of the 3D object by:
determining signs of the signed distance values of the other neighboring voxels; and
in response to the signed distance values for the other neighboring voxels including at least one positive sign distance value and at least one negative sign distance value, determining that the voxel is located near the surface of the 3D object.

15. The system of claim 14, wherein:
the other neighboring voxels include, for each voxel in the first voxel grid, a three-by-three-by-three voxel grid of voxels surrounding the voxel; and
the one or more processing devices perform additional operations comprising upsample, for each voxel not near the surface of the 3D object, the signed distance value of the voxel into the signed distance value of one or more additional voxels using trilinear interpolation.

16. The system of claim 13, wherein:
the machine-learning model is a multilayer perceptron;
for each target voxel, an input to the multilayer perceptron is a 64-dimensional input vector that includes the signed distance values for the neighboring voxels of the target voxel in a four-by-four-by-four voxel grid surrounding the target voxel; and
for each target voxel, an output from the multilayer perceptron is an eight-dimensional output vector that includes the signed distance values of the multiple voxels in a two-by-two-by-two voxel grid upsampled from the target voxel.

17. The system of claim 16, wherein the multilayer perceptron is trained to determine the output vector based on:
synthetic 3D shape data generated by performing geometry operations between random selections of primitive shapes, the primitive shapes including cuboids, spheres, cylinders, and pyramids; and
additional synthetic 3D shape data generated by applying Gaussian filters on the synthetic 3D shape data.

18. One or more computer-readable media storing instructions that, responsive to execution by a processing device, causes the processing device to perform operations comprising:
receive a first voxel grid having a first resolution to represent a three-dimensional (3D) object;
for each target voxel near a surface of the 3D object, upsample, using a machine-learning model and based on neighboring voxels, the target voxel into multiple voxels in a second voxel grid having a second resolution that is greater than the first resolution; and
render, using the multiple voxels in the second voxel grid, the 3D object.

19. The one or more computer-readable media of claim 18, wherein:
the one or more computer-readable media comprises modeling software based on volumetric sculpting with signed distance values for each voxel in the first voxel grid; and
the one or more computer-readable media stores additional instructions that, in response to execution by the processing device, cause the processing device, for each voxel in the first voxel grid, to determine, based on the signed distance values of other neighboring voxels, whether the voxel is located near the surface of the 3D object.

20. The one or more computer-readable media of claim 19, wherein:
the machine-learning model is a multilayer perceptron;
for each target voxel, an input to the multilayer perceptron is a 64-dimensional input vector that includes the signed distance values for the neighboring voxels of the target voxel in a four-by-four-by-four voxel grid surrounding the target voxel; and
for each target voxel, an output from the multilayer perceptron is an eight-dimensional output vector that includes the signed distance values of the multiple voxels in a two-by-two-by-two voxel grid upsampled from the target voxel.
